(19) United States
(12) Patent Application Publication
(10) Pub. No.: US 2012/0163637 A1
(43) Pub. Date: Jun. 28, 2012

(54) SPEAKER ASSEMBLY

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/104,027

(22) Filed: May 10, 2011

(30) Foreign Application Priority Data
Dec. 24, 2010 (CN) 201010604421.7

(51) Int. Cl. H04R 1/02

(52) U.S. Cl. 381/184

(57) ABSTRACT

An exemplary speaker assembly includes a woofer, a supporting member, a fixing member and a tweeter. The woofer includes a magnetic circuit unit defining an air gap, a frame mounted on the magnetic circuit unit, a diaphragm received in and connected to the frame, and a voice coil extending through a center of the diaphragm. One end of the voice is secured to the diaphragm, and the other end of the voice coil is interposed into the air gap of the magnetic circuit unit. The supporting member is disposed on the magnetic circuit unit and enclosed by the voice coil. A top end of the supporting member extends through the diaphragm to an outer side of the diaphragm. The fixing member extends through the magnetic circuit unit to mount the supporting member on the magnetic circuit unit. The tweeter is secured to and supported by the supporting member.

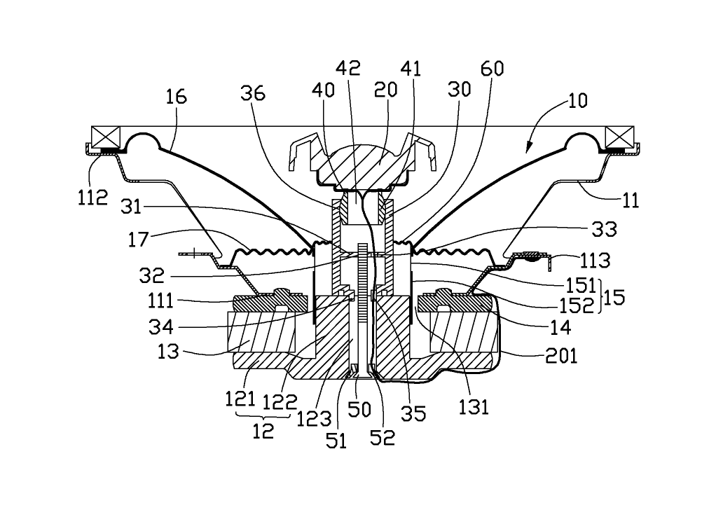

### BACKGROUND

1. Technical Field

The disclosure generally relates to speaker assemblies, and more particularly to a speaker assembly having a woofer and a tweeter mounted together.

2. Description of Related Art

In some applications, a speaker assembly is provided with both a woofer and a tweeter to increase the frequency range of sound. Generally, the woofer and the tweeter are individually mounted into different locations of a housing. Thus, the assembly process is time consuming, and the woofer and the tweeter occupy a large amount of space within the housing.

What is needed, therefore, is a speaker assembly to overcome the described limitations.

### BRIEF DESCRIPTION OF THE DRAWING

The sole drawing is a cross-sectional view of a speaker assembly in accordance with an exemplary embodiment of the present disclosure.

### DETAILED DESCRIPTION

The drawing shows a speaker assembly in accordance with an exemplary embodiment of the present disclosure. The speaker assembly includes a woofer 10, a tweeter 20, a supporting member 30, a connecting member 40 and a fixing member 50. The tweeter 20 is mounted to the woofer 10 by the supporting member 30, the connecting member 40 and the fixing member 50.

The woofer 10 includes a frame 11, a yoke 12, a magnet 13, a washer 14, a voice coil 15, a diaphragm 16 and a damper 17.

The yoke 12 has a substantially T-shaped cross-section, and includes a circular bottom wall 121 and a cylindrical post 122 extending upward from a center of the bottom wall 121. A through hole 123 is axially defined in a center of the yoke 12. The through hole 123 extends through the bottom wall 121 and the post 122, for the fixing member 50 to extend through. The magnet 13 and the washer 14 each are annular. The magnet 13 and the washer 14 are successively superposed on the bottom wall 121 of the yoke 12, and surround the post 122 of the yoke 12. Inner peripheral surfaces of the washer 14 and the magnet 13, and an outer peripheral surface of the post 122 of the yoke 12, cooperatively define an annular air gap 131 therebetween. In this embodiment, the yoke 12, the magnet 13 and the washer 14 cooperatively constitute a magnetic circuit unit for the woofer 10 with the air gap 131 therein.

In other embodiments, the woofer 10 can be provided with another kind of conventional magnetic circuit unit, such as a magnetic circuit unit including a U-yoke having a U-shaped cross-section, a disc-shaped magnet and a disc-shaped washer. The disc-shaped magnet and the disc-shaped washer are received in the U-yoke. In such embodiments, a through hole for insertion of the fixing member 50 extends through the disc-shaped washer, the disc-shaped magnet and a bottom wall of the U-yoke.

The frame 11 is generally horn-shaped, with a bottom small end 111 and a top big end 112. The small end 111 of the frame 11 is disposed on and connected to the washer 14. Alternatively, the washer 14 can be integrally formed with the frame 11 as a single monolithic piece of the same material. The frame 11 forms an electrical terminal 113 on an outer edge thereof adjacent to the small end 111.

The voice coil 15 includes a hollow cylindrical bobbin 151, and a coil 152 wound around a bottom portion of the bobbin 151. The voice coil 15 encloses a top portion of the post 122 of the yoke 12 therein. The coil 152 of the voice coil 15 is partly interposed into a top of the air gap 131. In the air gap 131, the bobbin 151 and the coil 152 can move up and down along an axial direction of the bobbin 151. The diaphragm 16 is formed from a resin or a paper material into a cone shape, and defines an axial through hole (not labeled) in a center thereof. The diaphragm 16 is arranged in the frame 11 around the voice coil 15. A small end of the diaphragm 16 is secured to a top portion of the voice coil 15, whereby the diaphragm 16 can move together with the voice coil 15. A big end of the diaphragm 16 is secured to the big end 112 of the frame 11. The damper 17 is formed from a resin-impregnated cloth or a thin resin plate into a ring shape. The damper 17 is located between the diaphragm 16 and the small end 111 of the frame 11. The damper 17 encloses the voice coil 15 therein. An inner peripheral edge of the damper 17 is connected to the voice coil 15, and an outer peripheral edge of the damper 17 is connected to the frame 11. Thereby, irregular vibration of the diaphragm 16 is prevented, and the sound quality is improved.

The supporting member 30 is a hollow pole (or post). A mounting plate 31 is formed inside and located at a middle of the pole. The mounting plate 31 divides an inner space of the supporting member 30 into a top region above the mounting plate 31 and a bottom region under the mounting plate 31. A mounting hole 32 is defined in a center of the mounting plate 31 for engagingly receiving the fixing member 50. The mounting plate 31 further defines a wire hole 33 therein adjacent to the mounting hole 32, for a set of electrical wires 201 to extend through. The set of electrical wires 201 electrically connects the tweeter 20 with the electrical terminal 113 of the frame 11 of the woofer 10. The supporting member 30 forms a positioning portion 34 in the bottom region, adjacent a bottom end of the supporting member 30. The positioning portion 34 is a ring, and defines a wire groove 35 therein for the set of electrical wires 201 to extend through. The supporting member 30 defines an annular contacting groove 36 in an inner circumferential surface thereof above the mounting plate 31. The supporting member 30 forms a spherical inner surface defining the contacting groove 36. That is, such inner surface is annular and curved, and forms part of the surface of a single imaginary sphere. In the illustrated embodiment, a transverse cross-section of such inner surface taken at any radius of the imaginary sphere is arc-shaped.

The supporting member 30 is arranged on the post 122 of the yoke 12. The positioning portion 34 of the supporting member 30 is inserted into the through hole 123 of the yoke 12. A top end of the supporting member 30 extends upward through the through hole of the diaphragm 16 to an outer side of the diaphragm 16. The fixing member 50 extends upward from a bottom side of the yoke 12 through the through hole 123 of the yoke 12 and engages in the mounting hole 32 of the mounting plate 31 of the supporting member 30, thereby fixing the supporting member 30 to the post 122 of the yoke 12. In this embodiment, the fixing member 50 is a bolt, and the yoke 12 forms a chamfer at a bottom of the through hole 123. A gasket 51 is arranged at the chamfer. The gasket 51 defines a wire groove 52 therein for the set of electrical wires 201 to extend through.

The tweeter 20 is arranged at a top of the supporting member 30, and is mounted to the supporting member 30 by the connecting member 40. A top portion of the connecting member 40 is connected to a bottom of the tweeter 20. A bottom portion of the connecting member 40 forms a connecting head 41 with a spherical outer surface. That is, such outer surface is annular and curved, and forms part of the surface of a single imaginary sphere. In the illustrated embodiment, a transverse cross-section of such outer surface taken at any radius of the imaginary sphere is arc-shaped. At least one of the connecting member 40 and supporting member 30 is made of elastic material such as rubber. The connecting member 40 is pressed downward to make the connecting head 41 enter the contacting groove 36 of the supporting member 30. As described above, the connecting head 41 and the contacting groove 36 each are spherical, therefore the connecting member 40 together with the tweeter 20 can rotate relative to the supporting member 30 in any direction. Thus, in the speaker assembly, the direction of sound radiating from the tweeter 20 can be adjusted by adjusting the connecting member 40 to adapt for different applications.

The connecting member 40 defines an axial through hole 42 therein, to save material and to allow the set of electrical wires 201 to extend through the connecting member 40. The connecting member 40 further defines two wire grooves (not labeled) in a top portion thereof, for the set of electrical wires 201 to extend through. One end of the set of electrical wires 201 is connected to the tweeter 20. The set of electrical wires 201 successively extends through the connecting member 40, the supporting member 30 and the yoke 12, and the other end of the set of electrical wires 201 is connected to the electrical terminal 113 of the frame 11 of the woofer 10.

In this embodiment, the woofer 10 further includes another annular damper 60 enclosing the supporting member 30. The damper 60 is located between the diaphragm 16 and the tweeter 20. An inner peripheral edge of the damper 60 is connected to the supporting member 30, and an outer peripheral edge of the damper 60 is connected to the diaphragm 16. The damper 60 can also prevent irregular vibration of the diaphragm 16 to further improve the sound quality.

In the speaker assembly, the tweeter 20 is mounted on the magnetic circuit unit of the woofer 10. When the speaker assembly is mounted to a casing (or housing), the assembly process is convenient and the speaker assembly occupies a relatively small space inside the casing.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A speaker assembly comprising:
a woofer comprising:
a magnetic circuit unit defining an air gap therein;
a frame mounted on the magnetic circuit unit;
a diaphragm received in and connected to the frame; and
a voice coil extending through a center of the diaphragm, one end of the voice coil being secured to the diaphragm, the other end of the voice coil being interposed into the air gap of the magnetic circuit unit;
a supporting member disposed on the magnetic circuit unit and enclosed by the voice coil, a top end of the supporting member extending through the diaphragm to an outer side of the diaphragm;
a fixing member extending through the magnetic circuit unit to mount the supporting member on the magnetic circuit unit; and
a tweeter secured to and supported by the supporting member.

2. The speaker assembly of claim 1, further comprising a connecting member, the tweeter being rotatably secured to the supporting member by the connecting member.

3. The speaker assembly of claim 1, wherein the magnetic circuit unit comprises a yoke, an annular magnet and an annular washer, the yoke having a bottom wall and a post extending upward from a center of the bottom wall, the magnet and the washer being successively superposed on the bottom wall of the yoke and surrounding the post of the yoke, the frame being secured to the washer, the air gap being annular and defined between inner peripheral surfaces of the washer and the magnet and an outer peripheral surface of the post of the yoke, and the supporting member being mounted on the post of the yoke.

4. The speaker assembly of claim 3, further comprising a connecting member, the tweeter being rotatably secured to the supporting member by the connecting member.

5. The speaker assembly of claim 4, wherein a top portion of the connecting member is connected to the tweeter, a bottom portion of the connecting member forms a connecting head, the supporting member defines an annular contacting groove in an inner circumferential surface thereof, and the connecting head of the connecting member is movably received in the contacting groove of the supporting member.

6. The speaker assembly of claim 5, wherein the connecting head has a spherical outer surface, the supporting member forming a spherical inner surface defining the contacting groove.

7. The speaker assembly of claim 6, wherein the connecting member defines an axial through hole therein.

8. The speaker assembly of claim 4, wherein an axial through hole is defined in a center of the yoke, and extends through the bottom wall and the post for the fixing member to extend through.

9. The speaker assembly of claim 8, wherein the supporting member forms a positioning portion adjacent a bottom end thereof, the positioning portion of the supporting member being inserted into the through hole of the yoke.

10. The speaker assembly of claim 8, wherein the supporting member is a hollow pole, a mounting plate being formed inside and located at a middle of the pole, the fixing member being a bolt, and the bolt extending upward from a bottom side of the yoke through the through hole of the yoke and engaging with the mounting plate of the supporting member.

11. The speaker assembly of claim 10, further comprising a set of electrical wires, the frame of the woofer forming an electrical terminal on an outer edge thereof, one end of the set of electrical wires being connected to the tweeter, the set of electrical wires successively extending through the connecting member, the supporting member and the yoke, and the other end of the set of electrical wires being connected to the electrical terminal of the frame of the woofer.

12. The speaker assembly of claim 11, wherein the yoke forms a chamfer at a bottom of the through hole thereof, a gasket is arranged at the chamfer, and the gasket defines a wire groove therein for the set of electrical wires to extend through.

13. The speaker assembly of claim 1, further comprising an annular damper, the damper enclosing the supporting member and being located between the diaphragm and the tweeter, an inner peripheral edge of the damper being connected to the supporting member, and an outer peripheral edge of the damper being connected to the diaphragm.

14. The speaker assembly of claim 2, further comprising an annular damper, the damper enclosing the supporting member and being located between the diaphragm and the tweeter, an inner peripheral edge of the damper being connected to the supporting member, and an outer peripheral edge of the damper being connected to the diaphragm.

15. A speaker assembly comprising:
a woofer comprising:
a magnetic circuit unit defining an air gap therein;
a frame mounted on the magnetic circuit unit;
a diaphragm received in and connected to the frame; and
a voice coil extending through a center of the diaphragm, one end of the voice coil being secured to the diaphragm, the other end of the voice coil being interposed into the air gap of the magnetic circuit unit;
a supporting member disposed on and mounted to the magnetic circuit unit, the supporting member being enclosed by the voice coil, a top end of the supporting member extending through the diaphragm to an outer side of the diaphragm;
a tweeter arranged above the supporting member; and
a connecting member connected between the supporting member and the tweeter, and rotatably securing the tweeter to the supporting member.

16. The speaker assembly of claim 15, wherein the magnetic circuit unit comprises a yoke, an annular magnet and an annular washer, the yoke having a bottom wall and a post extending upward from a center of the bottom wall, the magnet and the washer being successively superposed on the bottom wall of the yoke and surrounding the post of the yoke, the frame being secured to the washer, the air gap being annular and defined between inner peripheral surfaces of the washer and the magnet, and an outer peripheral surface of the post of the yoke, the supporting member being mounted on the post of the yoke.

17. The speaker assembly of claim 16, further comprising an annular damper, the damper enclosing the supporting member and being located between the diaphragm and the tweeter, an inner peripheral edge of the damper being connected to the supporting member, and an outer peripheral edge of the damper being connected to the diaphragm.

18. The speaker assembly of claim 16, wherein a through hole is axially defined in a center of the yoke, and extends through the bottom wall and the post for the fixing member extending through, the supporting member forming a positioning portion adjacent a bottom end thereof, the positioning portion of the supporting member being inserted into the through hole of the yoke.

19. The speaker assembly of claim 15, wherein a top portion of the connecting member is connected to the tweeter, a bottom portion of the connecting member forming a connecting head, the supporting member defines an annular contacting groove in an inner circumferential surface thereof, the connecting head of the connecting member being engagingly received in the contacting groove of the supporting member.

20. The speaker assembly of claim 15, further comprising an annular damper, the damper enclosing the supporting member and being located between the diaphragm and the tweeter, an inner peripheral edge of the damper being connected to the supporting member, and an outer peripheral edge of the damper being connected to the diaphragm.
